(19) United States
(12) Patent Application Publication
(10) Pub. No.: US 2026/0330083 A1
(43) Pub. Date: Oct. 22, 2026

(54) METHOD OF MANUFACTURING WALL, FLOOR AND WINDOW COVERINGS AND UPHOLSTERY WITH VARYING DESIGNS

(71) Applicant: Mosa Holding B.V., MAASTRICHT (NL)

(72) Inventors: Lambertus Antonius Maria KIGGEN, MAASTRICHT (NL); Josephina Johanna Petronella MAASE - JANSEN, MAASTRICHT (NL)

(21) Appl. No.: 19/115,733

(22) PCT Filed: Sep. 27, 2023
(86) PCT No.: PCT/NL2023/050505

§ 371 Date: Mar. 26, 2025

(30) Foreign Application Priority Data
Sep. 27, 2022 (NL) 2033149

(51) Int. Cl. G06F 30/17; G06F 113/10

(52) U.S. Cl. CPC G06F 30/17; G06F 2113/10

(57) ABSTRACT

Computer implemented method of generating design instances for manufacturing a series of products comprising a respective design instance, wherein said products comprise one or more of the group of wall, floor, window coverings and upholstery, comprising the steps of: defining a procedural processing graph comprising a plurality of nodes and interconnections, wherein each node and said graph has associated parameters, wherein said graph associated parameters at least define a number of designs instances within said series of products, and wherein said node associated parameters at least define design parameters for algorithm modification of one or more geometric primitive within a predefined variation range; executing said procedural processing graph, generating a number of designs instances as defined by said graph associated parameter, wherein each design instance varies with a computer-generated randomness within said variation range defined in accordance with said node associated parameters; manufacturing said series of products.

### SUBJECT OF THE PRESENT INVENTION

The present disclosure relates to a method for manufacturing wall, floor and window coverings and upholstery which products have a certain aesthetic design or print on surface of the product.

### BACKGROUND OF THE INVENTION

Throughout the present disclosure wall coverings, floor coverings, window coverings as well as upholstery are in general referred to as products. Thus, the present disclosure and the appending claims may be referring to products, which applies at least to all types of wall coverings, floor coverings, window coverings and upholstery, which contains on a surface thereof an aesthetic design.

These products may have a certain design, by which the product obtains its uniqueness and which is considered to significantly increase the value of the product.

The design is an important and thus also distinguishing step in the manufacturing process of such products, which process can be categorized roughly into three categories, hand-crafted, mechanically produced, and fully digitally designed and produced, as well as a combination of the foregoing.

Each of these three categories have specific properties with respect to aesthetic appearance, and the degree of uniqueness or repetition of the design in a series of products. A higher degree of uniqueness or lower degree of repetition of the design is on the one hand typically considered to increase the value of the product.

Hand-crafted products may be considered to have the highest intrinsic natural variation. Such natural variation is considered to increase the aesthetic value significantly. Hand-crafted products however cannot be manufactured on large, industrial scale, and constancy in the quality of the production process is also challenging.

Industrially manufactured products such as ceramic tiles, are on the other hand very constant in quality but mostly also limited in aesthetic variation. Typically, the aesthetic variation has to be generated manually. This is currently done by firstly designing a master design which is the basic design for the whole series of products. To introduce natural or natural-like variation, the design is modified according to certain image properties chosen by the designer but always restricted by the size or more in general, the properties of the master design and thus master file. The variation can in addition or as alternative, also be introduced within the manufacturing process, by adding a certain level of variation to certain steps of the process. For example, dyes, pigments or additives may be sprinkled, or strewed our spread out over the visible surface of the ceramic tile to assure the natural variation of each tile. As such, a certain level of variation and therefore uniqueness is created within a certain mechanical production step.

Such process variation by mechanical product steps however requires complex or even manual steps in the manufacturing process. Moreover, not all designs can be manufactured this way.

Printing techniques are becoming increasingly popular and, contrary to mechanical production steps, allow a large variation in designs and complexity thereof. With such digital printing techniques the predefined design is printed directly and precisely onto the surface of the product, hence on the front (view) side of the material. To introduce variation in such printed designs, the designer has to make a series of designs, i.e. 8, 16, 24, 32 or more different variations or instances taken from the original master design. Such instances may also be referred to as faces. Obtaining such number of different faces with design variations is time consuming, complex and requires certain skills of the designer.

In addition the amount of unique instances or faces is limited causing repetition in the pattern surface when the material is in function as wall, floor or window coverings or as upholstery. Especially for large surfaces, such as large industrial, residential or commercial floors and/or walls, such repetition of the pattern may be well visible which has a negative effect on the overall aesthetic appearance and thus value of the product.

Accordingly, it is an object of the present invention to provide for an improved manufacturing process for manufacturing products such as wall coverings, floor coverings, window coverings as well as upholstery, which manufacturing process allows a high and preferably unlimited degree of uniqueness or variation, which is suitable for printing techniques.

### SUMMARY OF THE INVENTION

The foregoing object is achieved, in a first aspect of the present disclosure, a computer implemented method of generating design instances for manufacturing a series of products comprising a respective design instance, wherein said products comprise one or more of the group of wall, floor, window coverings and upholstery, and wherein said method is performed by a computing device, and comprising the steps of:
defining a procedural processing graph, said graph comprising a plurality of nodes and interconnections between at least some of said plurality of nodes, wherein each node has associated parameters and said graph has associated parameters, wherein said graph associated parameters at least define a number of designs instances within said series of products, and wherein said node associated parameters at least define design parameters for algorithm modification of at least one geometric primitive within a predefined variation range,
executing said procedural processing graph, generating a number of designs instances as defined by said graph associated parameter, wherein each design instance varies with a computer-generated randomness within said variation range defined in accordance with said node associated parameters;
manufacturing said series of products, wherein each product comprised in said series of products comprises a respective design instance generated according to said execution of said procedural processing graph.

With the present disclosure, in particular in the first aspect thereof, there is provided a computer implemented method to ease this process and to obtain product designs in an automated manner in which the tile designs may be considered instances, variations or faces of a master design.

Hence, the proposed method provides for a way of producing a physical object such, but not limited to a ceramic tiles. With the method a realization of a procedural process is provided which is implemented as an algorithm. The algorithm is arranged for and provides a defined and limited number, or undefined unlimited number of designs for such a ceramic tile which designs have automated randomization as for certain design elements or features. The randomization may be defined by input parameters and/or process parameters which are referred to as graph parameters and node parameters, by which the range of variation may be defined.

Contrary to known algorithmic uses in designs, the present method provides plural or even an unlimited amount of surface designs or also referred to as faces by which natural variation in given to each ceramic tile in an automated and computer generated manner. Known algorithmic uses only provide for a single design as a computer generated variant of an original design. Such algorithms thus firstly require a complete design and may output only one single variant thereof and are as such, not suitable and not tailored to introduce natural variation into each single manufactured physical product like a ceramic tile.

In accordance with the present disclosure, the proposed method is arranged for manufacturing a physical product such as a ceramic tile by generating a two dimensional graphical design.

With the present disclosure, in an example, the generated number of designs instances may be used in a multi layered design composition in which two or several instances are combined through layers into a single two dimensional design instance. This increases the level of variation of one single instance of face.

With the present disclosure, there is no need to have prefixed input. Hence, known algorithmic use of design may rely on certain fully designed inputs. For example, a complete design of a chair or the like, which can be varied in design by an algorithmic use of a design process. However, this not only creates only one design, it also relies on a full input, whereas the present method may comprise of only nodes with corresponding parameters, by which the computer generated design instances are generated without design start or design input into the procedure.

The proposed node-based generative design method provides a highly effective method for producing a diverse range of design variants, particularly suited for applications like ceramic tiles where the goal is to achieve a hand-crafted or naturally shaped appearance with subtle variations in each piece. With this method, design specifications may be given, including the tile's size, shape, and overall pattern, as well as identifying key parameters that control the natural variations, e.g. the node associated parameters and graph associated parameters.

Once nodes and parameters are set, the method may be executed through dedicated or known software or platforms that facilitate such a generative design workflow. Software tools may be used like Grasshopper for Rhino, Houdini, or procedural texture generators like Substance Designer which are suitable choices for this purpose.

A node-based network that represents the design process may be constructed this way. Nodes within this network may be used to manipulate and generate variations in the design. Here, introducing additional nodes that added controlled randomness to the design, which are affected by the parameters such as translation, rotation, and scaling as set in the node associated parameter. Adjusting these parameters will output a desired degree of randomness and variation.

To impart an organic, naturally shaped appearance to the design, nodes may be defined that generate fractal or procedural patterns. These nodes can produce intricate, irregular shapes reminiscent of natural patterns found in handmade or naturally formed objects and may thus have such corresponding parameters to set such.

Additionally, nodes may be incorporated to manage texture and material properties. These nodes may add more natural simulation of the surface texture and appearance of ceramic tiles, which is beneficial for achieving the desired aesthetic.

The proposed generative design process may be iterated once, several or a large number of times, generating multiple design variants or even increase the variance or level of detail of a single design. The number of iterations may thus determine the diversity in designs. Each generated design variant may be visually controlled to ensure they align with predefined and required criteria such that a hand-made or naturally shaped appearance may be achieved. Fine-tune of some or all of the nodes and parameters may increase the level of meeting this objective.

Once the designs are as expected and as desired, they may be exported in the appropriate design formats for ceramic tile production, ensuring compliance with manufacturing requirements. Before proceeding to mass production, quality control tests may be implemented in an automated way, i.e. to determine if a certain threshold of variation and likeliness is achieved. By such quality control, the printed ceramic tiles are verified to maintain the desired natural variation and hand-made appearance. This meticulous approach ensures that each tile exhibits a unique, naturally shaped quality, delivering a hand-crafted feel to the finished product.

The skilled person will appreciate that ceramic tiles are just one of the example in which the proposed method may be used and that the procedural approach of design variation may also be applicable to other physical products to achieve desired natural variation and hand-made appearance or to achieve other types of variation as specified and defined by the nodes and associated parameters.

The method may be performed by a computing device, which typically is a personal computer, e.g. either a general purpose computer or alternatively, a dedicated or embedded computer having certain dedicated hardware to for example improve the processing power for repetitive limited functions to obtain hardware acceleration.

With the method, product designs may be obtained which allow manufacturing of plural individual products. These products may be produced/manufactured in series consisting of 1 to an unlimited number of different variations in designs, i.e. instance designs or faces. Contrary to known design methods in the production processes which involve printing techniques, the presented method is not limited to a series of for example 4, 8, 16 or 24 variations or faces which typically form such a series. Hence, in accordance with the present disclosure, with the procedural processing graph any number of instances can be generated, which defines the series as those instances which are generated by a particular procedural processing graph.

To obtain design variations, the method further comprises the step of defining a procedural processing graph. The graph is a layout containing at least nodes and interconnections which connect nodes with one or multiple further nodes. The graph may have a sequential character, meaning that one node may define a start of the graph, and one or several other nodes as end nodes. This is however not mandatory, as the graph may also comprises nodes which belong to a sub-group of nodes which may be executed as a group in either a serial or sequential manner, a parallel manner or in a combination of both. The graph may contain several parameters which can be related or associated to either the nodes or the graph itself. The nodes may define certain procedural steps such as variational ranges of certain image properties or elements, whereas the parameters relates to the graph itself may at least define how many instances of the design are to be generated. The instances are also referred to as distinct product designs for the manufacturing of a series of products such as, but not limited to ceramic tiles, which provide a huge variations within the instances resulting and thereby aesthetic appealing surface.

The nodes define the design parameters for an algorithmic modification of the geometric primitives. Geometric primitives are, in accordance with the present disclosure, to be understood as image or graphical elements which can be expressed in a mathematical manner, for example as typical graphics. Geometric primitives may also comprise routines or subroutines defining a certain computer program code which, when executed by a computer, generate a graphical element, e.g. to be shown on a display or printed by a printer. The geometric primitives, according to the present disclosure, may comprise one or several simple or complex pixel and/or vector based geometric shapes such as cubes, cylinders, cones or any linear or non-linear shape or polygon. It may also comprise lines, points, or shapes, planes, but also three dimensional shapes like spheres, cubes, boxes or toroid. The skilled person will appreciate that such geometric primitives thus may include any geometrically or mathematically definable graphic, contrary to for example bitmaps.

Due to the concept of the geometrically or mathematically definable graphic elements which are defined by the nodes as geometric primitives, the graph can be configured such that various modifications and thus variations can be made from these graphic elements, for example, adding constants to the mathematical representation of the element, to enlarge, reduce, stretch, rotate, or perform any type of transformation of the graphical element, hence geometric primitive.

In an example, the nodes makes it possible to create a dedicated new alphabet using graphical elements such as dots and stripes. Several nodes are build up upfront and specified per each graphical element of this new alphabet. A designer can pick out some of these nodes (just like in a tool box) and eventually link them together in a specific manner in a node graph, blend them and even set different color variations to create the visual concept specifically for the project he/she is working on. This visual concept can be used to procedurally and algorithmically generate faces for horizontal and vertical surfaces for any type of space.

Hence, in an example, the method further comprises the step of using a tool-box which comprises a number of predefined nodes with one or more geometric primitives, for the designer to easily chose from in designing/configuring/programming a procedural processing graph. With such a tool-box nodes can be re-used and shared between several procedural processing graphs to aid the designer.

When the procedural processing graph has been generated or defined, the graph may be executed in the next step of the method. The execution of the graph may contain executing a predefined node and corresponding procedural steps defined by the node, or selecting a node prior to the actual execution of the graph, in which the selected node is the start node or single node executing during this step. Preferably however, the graph itself is executed by a single node being defined as the starting node of the graph and based on the interconnections with further nodes, the remaining parts of the graph may be executed accordingly.

By executing the graph in such a sequential, groupwise or single node based manner, the geometric primitive(s) is/are varied by the procedural processing graph into a predefined number of product designs which may be referred to as instances of the graph.

Now several product design instances are obtained which may be uploaded to the printer to print the respective product design onto a particular instance within the series of products. This is repeated for each instance within the series of products, on which a different instance design is printed respective.

The presented method may, in an example thereof be arranged to be performed by a computer device which is a dedicated, stand-alone device, used for configuring the procedural processing graph and outputting a defined number of instances. These instances may further be processed or pre-processed prior to uploading to the printer. Due to the requirement of the printer, the instance may be further converted, and/or additional data may be added to the file, which additional data may relate, for example, to printer settings, calibration data, or meta-data relating to the instance.

It is expressed, that in the present disclosure, the example is used of printing the digital design with a printer onto for example a ceramic tile, however, the present disclosure is not limit to such production methods only, as other digital production methods are also capable to use the design instances output by the computer-implemented method of the present disclosure. Hence, the present disclosure may also be used for tufting carpets, printing designs on plastic tiles, wall coverings, upholstery, in weaving, in embroidery, or any other decorative arts on a product which is arranged to process the design instances as digital image files or files converted into a file-format which is compatible and suitable for such industrial manufacturing processes.

In a further example, the conversion may be performed by a further automated computer implemented method, for example by a script or more general computer code which automatically converts the instance generated from the method according to the first aspect as described above, into an image and file format compatible for the (industrial) printer.

In a further example, adding the additional data or enriching the instance file e.g. with meta-data, may also be performed by a further automated computer implemented method, for example by a script or more general computer code which automatically adds or enriches the instance generated from the method according to the first aspect as described above, with the additional data or meta-data.

In an example, the presented method may also be arranged to continuously generate new instances on the basis of a defined procedural processing graph, and wherein the computer in which the method is embodied, is either in communicative connection with the printer, or forms an integral part of the printer. As an alternative, the method may also be embodied in the computer or controller of the printer.

In an example, the number of design instances is set to a limited number for said computing device to perform said method by generating a predefined series of instances in accordance with said limited number.

In an example, the number of design instances is set to continuous for said computing device to perform said method by generating a continues series of instances.

In an example, the step of manufacturing said series of products, comprises printing with an industrial printer, each product comprised in said series of products with a respective instance design generated according to said execution of said procedural processing graph.

In an example, the printer is a flatbed digital printer, and in particular a flatbed ultra violet printer.

In an example, the product is a wall tile, in particular a ceramic wall tile.

In another example, the product is a floor tile, in particular a ceramic floor tile.

In another example, the product is a window covering.

In another example, the product is upholstery.

In a second aspect, there is provided a computer-readable medium comprising instructions which, when executed by a computer, cause the computer to carry out the steps of the method according to the first aspect.

The present disclosure also provides, in an further aspect, a computer program product, comprising program code means stored on a computer readable medium, the code means being arranged to perform the method according to the first aspect of the present disclosure, when the program code is executed by a computer, in particular wherein the code means are arranged for being integrated in or added to a computer application for joint execution of the program code and the computer application by a computer.

A computer readable medium may comprise any of a transitory or non-transitory computer readable medium as known to those skilled in the art. Non-transitory computer readable media for the purpose of the present disclosure include but are not limited to any of optically, magnetically, solid state semiconductor or other media, such as designated Compact Discs, CDs, Digital Versatile Disks, DVDs, flash memory, memory sticks, Hard Disk Drives, HDDs, Solid State Drives, SDDs, etc.

The above-mentioned and other features and advantages of the present disclosure will be best understood from the following detailed description referring to the attached drawing. In the drawings, like reference numerals denote identical parts or parts performing an identical or comparable function or operation. The examples provided are for illustrative purposes only and may not be construed as limitative for the present disclosure, its use and the scope of protection conferred by the appending claims.

### BRIEF DESCRIPTION OF THE DRAWINGS

FIG. 1 shows several steps of a computer-implemented method according to an aspect of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments.

The present disclosure relates to a computer implemented method. The method may be employed by a computer or computing device, which device may be a single device or a cluster of hardware and may comprise computing hardware or a virtualization of a computer system on one or several computer systems. The method may be employed by a computer from a remote location, e.g. in a data centre or such, or on-location, which means that the hardware is located near the hardware of the designers which define the procedural processing graph and may design input or configure nodes thereof. The computer may however also be located close to the production facility which means that it is directly or closely connected to the printer which eventually prints the designs on the products.

It is expressed that the computer-implemented method according to any of the aspects and examples of the present disclosure may be used for several types of products, wherein these products at least relate to the coverings, claddings, and structural elements for building. In particular, the products may comprise wall coverings or floor coverings, such as tiles, e.g. stone based tiles, glass-based tiles, ceramic tiles, or concrete-based tiles. The products may however also comprise textiles such as window coverings and upholstery. In general, every product which is suitable to be printed with a certain design. Typically, such a design may comprise a several instances or also referred to as faces.

Typically, the number of faces is limited and refers to the number of different patterns of a certain product. For example, high-end tiles may typically have 9 up to 25 different faces, which all originate from the procedural processing graph. Increasing the number of faces or instances will make such a product look more realistic as the likelihood that one can detect two identical faces, will increase which is considered to lower attractiveness and thereby commercial value.

Especially for those products nature based designs such as ceramic tiles with a marble designs, the need for high numbers of faces is highly desirable as recognizing repetition in the design throughout several tiles is more likely due to the intrinsic complex level of variation in nature. As such, increasing the degree of variation, by increasing the number of faces make it more authentic.

With the proposed computer implemented method enables large or even an unlimited number of different, unique design instances or faces such that a high level of authenticity can be obtained, without the need for labour intensive designing and illustration which is typically involved when a design for a product requires large number of instances or faces.

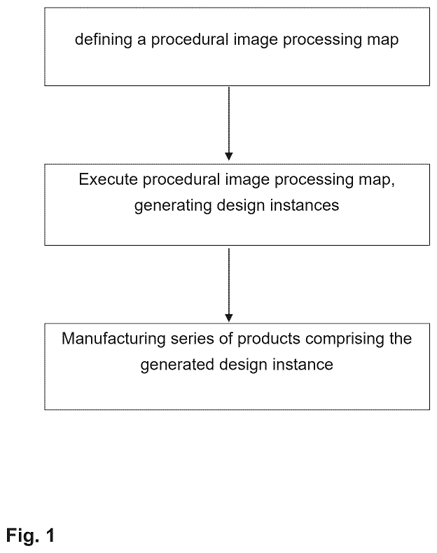

The method proposes is, in its broadest implementation thereof, comprised of several steps, which are shown in FIG. 1.

In a first step, the designer or illustrator designs or programs at least one node, but typically a series of nodes as starting node(s) having a geometric primitive or having multiple geometric primitives. The geometric primitives can be stored in the computer as a data element as a procedural vector based file. Each procedural processing graph starts with one or alternatively several starting nodes, in which at least some mathematic graphical element is defined, also referred to as geometric primitives. These may comprise in a simplistic form a line or even a dot, but will typically comprise a certain graphical vector, which is thus a mathematical representation of the graphical element. The procedural processing graph generates each design instance, which design instance is also a data element, which may be an image file but may also contain image data in a non-typical image file format such as jpeg or TIFF. There may however be additional data, e.g. meta-data or more specifically, data which specifies certain information required in the manufacturing process such as a config file, calibration setting or in general a profile as for example typically used for printers and monitors. The design instance, in accordance with the present disclosure thus corresponds to the faces used in conventional design methods. Whereas in conventional designs, the master design is divided into a plurality of faces, the present invention is based on a procedural processing graph which, according to the configuration thereof, can output a predefined limited or unlimited number of design instances in a mathematically, computer-implemented manner. Hence, the procedural processing graph outputs distinct, instantiated design variants, referred to as design instances.

The design instances are used in the manufacturing of product by uploading the instance to a printer or controller thereof, for printing the design onto the product, e.g. the ceramic tile. The proposed method is especially useful for digital printing techniques, for example by use of an industrial printing. The printer may be an inkjet type printer or a flatbed printer which for example comprises LED UV-light sources to cure the ink onto the product. To this end, the printing process may comprise additional steps of providing a primer and/or coating prior to and after application of the printed design. Such additional steps however are outside the scope of the present disclosure and therefore not described in further detail.

The method comprises at least four steps, wherein as mentioned, the first step is to define at least one single node in the procedural processing graph which comprises a geometric primitive, which is either a simple vector for defining a geometric shape, or a complex vector to define complex geometric and mathematical shapes, or any step in between. The next step is to define the rest of the procedural processing graph. This graph may be defined and illustrated as a plurality of nodes. Each of these nodes has certain parameters associated therewith. These parameters may define one or more design elements such as an image element, or image properties such as tone levels, hue, saturation, shadings, etc. In general, the parameters may allow to configuring any element or property of an image which would conventionally be configured or set by the designer or illustrator upon designing faces from a conventional master design. For each node, and thus for each of these properties, the user may select, configure or define a certain predefined variation range within which the particular property may vary. This way the algorithm will select for every instance a random level of the property, but within the used defined range of variation. As such, nodes may comprise properties which define certain image element or color settings, such that every time the procedural processing graph is executed, a unique instance is generated within the design variation range defined by the designer or illustrator. The parameters may also relate to a certain segment or part of the design, e.g. defining certain appearance aspects, object aspects, texture aspects or behavioural aspects. These parameters may be considered particle settings which may define behaviour of graphical elements such as the way in which drops of liquid, light and gaseous substances may behave under certain physical effects such as rain, sun, weather conditions or movement of the object which is represented by the graphical element. These conditions may further be defined by the parameters, e.g. by defining a trace of the individual graphical elements. For example a parameter may relate to a trace direction, defining the direction in which a graphical element such as a raindrop is projected as if motion is captured to obtain an authentic and aesthetic appealing design instance when the graph is executed.

Further, the graph comprises interconnections between at least some of the nodes. These interconnections define relational information such as which elements are linked to each other and in which sequence the graph is executed and the instance generated. The graph also has associated parameters which define the number of instances, which may thus correspond to the number of faces of traditional designing and may be set at any number or at an unlimited number for continuous output of design instances.

Once the procedural processing graph is defined, the graph may be executed, by which the instances are generated and wherein each instance is a unique instance and in which the level of uniqueness, i.e. randomness is defined within predefined range of the associated parameters.

As such, design instances are generated, which may be stored locally or centrally by the computer which executes the procedural processing graph or directly onto a central storage or storage means within the printer.

In an example, there is also provided a script based computer routine which provides an interface between algorithm of the procedural processing graph and the printer, which interface may manually, or automatically modify or add data or data elements to the computer file of the design instance. The modification or conversion or addition of data may depend on the type of printer and the way in which the printer is configured. In an example, the printer may require calibration settings which are not added to the computer file of the design instance by the procedural processing graph algorithm, but which need to be added by the interface routine. In a further example, the interface routine may be operated in an automated manner, in which any computer file uploaded by the procedural processing graph algorithm is automatically converted or enriched with the additional data, and subsequently automatically uploaded to a storage means which is accessible by the printer. In yet another example, the printer may be configured to monitor the storage means, to automatically print a next product with the design instance stored on the storage means in a predefined order according to certain settings of the interface routine.

Other variations to the disclosed examples can be understood and effected by those skilled in the art in practicing the claimed disclosure, from a study of the drawings, the disclosure and the appended claims. In the claims, the word “comprising” does not exclude other elements or steps and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as optical storage medium or a solid-state medium supplied together with or as part of other hardware, but may also be distributed in other forms, such as via the internet or other wired or wireless telecommunication systems and storages. Any reference signs in the claims should not construed as limiting scope thereof. Similar reference signs denote similar or equivalent functionality.

The present disclosure is not limited to the examples as disclosed above, and can be modified and enhanced by those skilled in the art beyond the scope of the present disclosure as disclosed in the appended claims without having to apply inventive skills and for use in any data communication, data exchange and data processing environment.

1. A computer implemented method of generating design instances for manufacturing a series of products comprising a respective design instance, wherein said products comprise one or more of the group of wall, floor, window coverings and upholstery, and wherein said method is performed by a computing device, and comprising the steps of:
defining a procedural processing graph, said graph comprising a plurality of nodes and interconnections between at least some of said plurality of nodes, wherein each node has associated parameters and said graph has associated parameters, wherein said graph associated parameters at least define a number of design instances within said series of products, and wherein said node associated parameters at least define design parameters for algorithm modification of one or more geometric primitive within a predefined variation range,
executing said procedural processing graph, generating a number of design instances as defined by said graph associated parameter, wherein each design instance varies with a computer-generated randomness within said variation range defined in accordance with said node associated parameters;
manufacturing said series of products, wherein each said series of product comprises a respective design instance generated according to said execution of said procedural processing graph.

2. The computer implemented method of generating design instances in accordance with claim 1, wherein said method further comprises, after said step of execution said procedural processing graph, the step of:
pre-processing each design instance in accordance with predefined configuration variables, corresponding to an industrial printer by which said respective design instance is printed onto said product.

3. The computer implemented method of generating design instances in accordance with claim 1, wherein said method further comprises, after said step of execution said procedural processing graph, the step of:
pre-processing each design instance in accordance with predefined conversion variables, corresponding to an industrial printer by which said respective design instance is printed onto said product, wherein said conversion variables are arranged to convert a computer file comprising said design instance into an image format suitable for printing by said industrial printer.

4. The computer implemented method of generating design instances in accordance with claim 2, wherein said pre-processing step is performed by data processing apparatus comprising means for carrying out said pre-processing step.

5. The computer implemented method of generating design instances in accordance with claim 4, wherein said data processing apparatus is comprised in said computing device executing said procedural processing graph.

6. The computer implemented method of generating design instances in accordance with claim 4, wherein said data processing apparatus is comprised in a computing device in an industrial printer by which said respective design instance is printed onto said product.

7. The computer implemented method of generating design instances in accordance with claim 1, wherein said number of design instances is set to a limited number for said computing device to perform said method by generating a predefined series of instances in accordance with said limited number.

8. The computer implemented method of generating design instances in accordance with claim 1, wherein said number of designs instances is set to continuous for said computing device to perform said method by generating a continues series of instances.

9. The computer implemented method of generating design instances in accordance with claim 1, wherein said step of manufacturing said series of products, comprises printing with an industrial printer, each product comprised in said series of products with a respective design instance generated according to said execution of said procedural processing graph.

10. The computer implemented method of generating design instances in accordance with claim 9, wherein said printer is a flatbed digital printer, and in particular a flatbed ultra violet printer.

11. The computer implemented method of generating design instances in accordance with claim 1, wherein said product is a wall tile, in particular a ceramic wall tile, or a façade cladding tile.

12. The computer implemented method of generating design instances in accordance with claim 1, wherein said product is a floor tile, in particular a ceramic floor tile.

13. The computer implemented method of generating design instances in accordance with claim 1, wherein said product is a window covering.

14. The computer implemented method of generating design instances in accordance with claim 1, wherein said product is upholstery.

15. A computer-readable medium comprising instructions which, when executed by a computer, cause the computer to carry out the steps of the method of claim 1.
